(19) United States
(12) Patent Application Publication
(10) Pub. No.: US 2009/0040794 A1
(43) Pub. Date: Feb. 12, 2009

(54) Time-Multiplexed Multi-Output DC/DC Converters and Voltage Regulators

(75) Inventor: Richard K. Williams, Cupertino, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Sunnyvale, CA (US)

(21) Appl. No.: 11/835,792

(22) Filed: Aug. 8, 2007

(51) Int. Cl. H02M 3/335

(52) U.S. Cl. 363/21.14; 363/21.17; 363/26

(57) ABSTRACT

A boost switching converter with multiple outputs includes an inductor is connected between an input supply (typically a battery) and a node Vₓ. A low-side switch connects the node Vₓ and ground. Two or more output stages are included. Each output stage includes a high-side switch and an output capacitor. Each output stage is connected to deliver electrical current to a respective load. A control circuit is connected to drive the low-side switch and high-side switches in a repeating sequence. The inductor is first charged and then discharged into each output stage. In effect, a series of different switching converters are provided, each with a different output voltage.

### BACKGROUND OF THE INVENTION

Voltage regulation is commonly required to prevent variation in the supply voltage powering various microelectronic components such as digital ICs, semiconductor memory, display modules, hard disk drives, RF circuitry, microprocessors, digital signal processors and analog ICs, especially in battery powered application likes cell phones, notebook computers and consumer products.

Since the battery or DC input voltage of a product often must be stepped-up to a higher DC voltage, or stepped-down to a lower DC voltage, such regulators are referred to as DC-to-DC converters. Step-down converters are used whenever a battery's voltage is greater than the desired load voltage. Step-down converters may comprise inductive switching regulators, capacitive charge pumps, and linear regulators. Conversely, step-up converters, commonly referred to boost converters, are needed whenever a battery's voltage is lower than the voltage needed to power its load. Step-up converters may comprise inductive switching regulators or capacitive charge pumps.

Of the aforementioned voltage regulators, the inductive switching converter can achieve superior performance over the widest range of currents, input voltages and output voltages. The fundamental principal of a DC/DC inductive switching converter is based on the simple premise that the current in an inductor (coil or transformer) cannot be changed instantly and that an inductor will produce an opposing voltage to resist any change in its current.

The basic principle of an inductor-based DC/DC switching converter is to switch or “chop” a DC supply into pulses or bursts, and to filter those bursts using a low-pass filter comprising and inductor and capacitor to produce a well behaved time varying voltage, i.e. to change DC into AC. By using one or more transistors switching at a high frequency to repeatedly magnetize and de-magnetize an inductor, the inductor can be used to step-up or step-down the converter's input, producing an output voltage different from its input. After changing the AC voltage up or down using magnetics, the output is then rectified back into DC, and filtered to remove any ripple.

The transistors are typically implemented using MOSFETs with a low on-state resistance, commonly referred to as “power MOSFETs”. Using feedback from the converter's output voltage to control the switching conditions, a constant well-regulated output voltage can be maintained despite rapid changes in the converter's input voltage or its output current.

To remove any AC noise or ripple generated by switching action of the transistors, an output capacitor is placed across the output of the switching regulator circuit. Together the inductor and the output capacitor form a “low-pass” filter able to remove the majority of the transistors' switching noise from reaching the load. The switching frequency, typically 1 MHz or greater, must be “high” relative to the resonant frequency of the filter's “LC” tank. Averaged across multiple switching cycles, the switched inductor behaves like a programmable current source with a slow-changing average current.

Since the average inductor current is controlled by transistors that are either biased as “on” or “off” switches, then power dissipation in the transistors is theoretically small and high converter efficiencies, in the eighty to ninety percent range, can be realized. Specifically when a power MOSFET is biased as an on-state switch using a “high” gate bias, it exhibits a linear I-V drain characteristic with a low R_{DS}(on) resistance typically 200 milliohms or less. At 0.5 A for example, such a device will exhibit a maximum voltage drop I_{D}·R_{DS}(on) of only 100 mV despite its high drain current. Its power dissipation during its on-state conduction time is I_{D}²·R_{DS}(on). In the example given the power dissipation during the transistor's conduction is (0.5 A)²·(0.2Ω))=50 mW.

In its off state, a power MOSFET has its gate biased to its source, i.e. so that V_{GS}=0. Even with an applied drain voltage V_{DS} equal to a converter's battery input voltage V_{batt}, a power MOSFET's drain current I_{DSS} is very small, typically well below one microampere and more generally nanoamperes. The current I_{DSS} primarily comprises junction leakage.

So a power MOSFET used as a switch in a DC/DC converter is efficient since in its off condition it exhibits low currents at high voltages, and in its on state it exhibits high currents at a low voltage drop. Excepting switching transients, the I_{D}·V_{DS} product in the power MOSFET remains small, and power dissipation in the switch remains low.

Power MOSFETs are not only used to convert AC into DC by chopping the input supply, but may also be used to replace the rectifier diodes needed to rectify the synthesized AC back into DC. Operation of a MOSFET as a rectifier often is accomplished by placing the MOSFET in parallel with a Schottky diode and turning on the MOSFET whenever the diode conducts, i.e. synchronous to the diode's conduction. In such an application, the MOSFET is therefore referred to as a synchronous rectifier.

Since the synchronous rectifier MOSFET can be sized to have a low on-resistance and a lower voltage drop than the Schottky, conduction current is diverted from the diode to the MOSFET channel and overall power dissipation in the “rectifier” is reduced. Most power MOSFETs includes a parasitic source-to-drain diode. In a switching regulator, the orientation of this intrinsic P-N diode must be the same polarity as the Schottky diode, i.e. cathode to cathode, anode to anode. Since the parallel combination of this silicon P-N diode and the Schottky diode only carry current for brief intervals known as “break-before-make” before the synchronous rectifier MOSFET turns on, the average power dissipation in the diodes is low and the Schottky oftentimes is eliminated altogether.

Assuming transistor switching events are relatively fast compared to the oscillating period, the power loss during switching can in circuit analysis be considered negligible or alternatively treated as a fixed power loss. Overall, then, the power lost in a low-voltage switching regulator can be estimated by considering the conduction and gate drive losses. At multi-megahertz switching frequencies, however, the switching waveform analysis becomes more significant and must be considered by analyzing a device's drain voltage, drain current, and gate bias voltage drive versus time.

Based on the above principles, present day inductor-based DC/DC switching regulators are implemented using a wide range of circuits, inductors, and converter topologies. Broadly they are divided into two major types of topologies, non-isolated and isolated converters.

The most common isolated converters include the flyback and the forward converter, and require a transformer or coupled inductor. At higher power, full bridge converters are also used. Isolated converters are able to step up or step down their input voltage by adjusting the primary to secondary winding ratio of the transformer. Transformers with multiple windings can produce multiple outputs simultaneously, including voltages both higher and lower than the input. The disadvantage of transformers is they are large compared to single-winding inductors and suffer from unwanted stray inductances.

Non-isolated power supplies include the step-down Buck converter, the step-up boost converter, and the Buck-boost converter. Buck and boost converters are especially efficient and compact in size, especially operating in the megahertz frequency range where inductors 2.2 pH or less may be used. Such topologies produce a single regulated output voltage per coil, and require a dedicated control loop and separate PWM controller for each output to constantly adjust switch on-times to regulate voltage.

In portable and battery powered applications, synchronous rectification is commonly employed to improve efficiency. A step-down Buck converter employing synchronous rectification is known as a synchronous Buck regulator. A step-up boost converter employing synchronous rectification is known as a synchronous boost converter.

Synchronous Boost Converter Operation: As illustrated in FIG. 1, prior art synchronous boost converter 1 includes a low-side power MOSFET switch 9, battery connected inductor 2, an output capacitor 5, and “floating” synchronous rectifier MOSFET 3 with parallel rectifier diode 4. The gates of the MOSFETs driven by break-before-make circuitry 7 and controlled by PWM controller 6 in response to voltage feedback V_{FB} from the converter's output present across filter capacitor 5. BBM operation is needed to prevent shorting out output capacitor 5.

The synchronous rectifier MOSFET 3, which may be N-channel or P-channel, is considered floating in the sense that its source and drain terminals are not permanently connected to any supply rail, i.e. neither to ground or V_{batt}. Diode 4 is a P-N diode intrinsic to synchronous rectifier MOSFET 4, regardless whether synchronous rectifier is a P-channel or an N-channel device. A Schottky diode may be included in parallel with MOSFET 3 but with series inductance may not operate fast enough to divert current from forward biasing intrinsic diode 4. Diode 8 comprises a P-N junction diode intrinsic to N-channel low-side MOSFET 9 and remains reverse biased under normal boost converter operation. Since diode 8 does not conduct under normal boost operation, it is shown as dotted lines.

If we define the converter's duty factor D as the time that energy flows from the battery or power source into the DC/DC converter, i.e. during the time that low-side MOSFET switch 9 is on and inductor 2 is being magnetized, then the output to input voltage ratio of a boost converter is proportionate to the inverse of 1 minus its duty factor, i.e.

$$\frac{{V}_{out}}{{V}_{i n}} = \frac{1}{1 - D} ≡ \frac{1}{1 - {t}_{sw} / T}$$

While this equation describes a wide range of conversion ratios, the boost converter cannot smoothly approach a unity transfer characteristic without requiring extremely fast devices and circuit response times. For high duty factors and conversion ratios, the inductor conducts large spikes of current and degrades efficiency. Considering these factors, boost converter duty factors are practically limited to the range of 5% to 75%.

The Need for Multiple Regulated Voltages: Today's electronic devices require a large number of regulated voltages to operate. For example, smart phones may use more than twenty-five separate regulated supplies in a single handheld unit. Space limitations preclude the use of so many switching regulators each with separate inductors.

Unfortunately, multiple output non-isolated converters require multiple winding or tapped inductors. While smaller than isolated converters and transformers, tapped inductors are also substantially larger and taller in height than single winding inductors, and suffer from increased parasitic effects and radiated noise. As a result multiple winding inductors are typically not employed in any space sensitive or portable device such as handsets and portable consumer electronics.

As a compromise, today's portable devices employ only a few switching regulators in combination with a number of linear regulators to produce the requisite number of independent supply voltages. While the efficiency of the low-drop-out linear regulators, or LDOs, is often worse than the switching regulators, they are much smaller and lower in cost since no coil is required. As a result efficiency and battery life is sacrificed for lower cost and smaller size.

What is needed are switching regulators capable of producing multiple outputs from a single winding inductor, minimizing both cost and size.

### SUMMARY OF THE INVENTION

An embodiment of the present invention includes a boost switching converter with multiple outputs. For a typical implementation, an inductor is connected between an input supply (typically a battery) and a node Vₓ. A low-side switch connects the node Vₓ and ground. Two or more output stages are included. Each output stage includes a high-side switch and an output capacitor. Each output stage is connected to deliver electrical current to a respective load.

A control circuit is connected to drive the low-side switch and high-side switches in a repeating sequence. For a typical implementation, the first phase of this sequence connects the inductor between the input supply and ground. This causes the inductor to store charge in the form of a magnetic field.

During the second phase and following phases, each output stage is selected in turn. As each stage is selected, its high-side switch is enhanced. This causes current to flow from the inductor to the selected output stage including its output capacitor and load. The sequence then repeats with the inductor being recharged.

It should be appreciated that other sequences may be equally practical. This means, for example that the inductor may be charged more often (such as between each output stage activation) or less often. Activation of one or more output stages may also be prioritized on a static or dynamic basis.

Various methods may be used to regulate the boost switching converter. Typically, this involves pulse width modulation where the duration of activation of the output stages is varied. Inductor charging time may also be varied. Pulse frequency modulation schemes may also be used where the rate of output stage activation is modulated to match load conditions.

The converter just described operates as a boost converter. The voltage produced by each output stage exceeds the supply voltage. Typically, each output stage will produce a different output voltage so the converter operates as a series of two or more boost converters. It is also possible to implement an inverting converter using a related topology. A typical implementation of the inverting converter includes an inductor is connected between ground and a node Vₓ. A low-side switch connects the node Vₓ and an input supply (typically a battery). Two or more output stages are included. Each output stage includes a high-side switch and an output capacitor. Each output stage is connected to deliver electrical current to a respective load.

As described previously, a control circuit charges the inductor and activates the output stages in a repeating sequence. This causes each output stage to deliver a different output voltage with all output voltage being the opposite polarity of the supply voltage. In effect, the inverting converter operates as a series of inverters, with the number of inverters corresponding to the number of output stages.

### BRIEF DESCRIPTION OF THE DRAWINGS

FIG. 1A is a block diagram of a prior art synchronous boost converter.

FIG. 2 is a schematic of a time-multiplexed-inductor (TMI) dual-output synchronous boost converter.

FIG. 3A is a schematic showing the operation of a dual-output TMI synchronous boost converter during a phase in which the inductor is magnetized.

FIG. 3B is a schematic showing the operation of the dual-output TMI synchronous boost converter of FIG. 3A during a phase in which charge is transferred to V_{OUT1} (C).

FIG. 3C is a schematic showing the operation of the dual-output TMI synchronous boost converter of FIG. 3A during a phase in which charge is transferred to V_{OUT2} (C).

FIG. 4 is a flowchart showing the algorithm of the dual output TMI synchronous boost converter.

FIG. 5A is a graph showing the switching-waveforms of the dual output TMI synchronous boost converter.

FIG. 5B is a graph showing the switching-waveform with emphasis on break-before-make behavior of the dual output TMI synchronous boost converter.

FIG. 6 shows an implementation of the dual output TMI synchronous boost converter using a P-channel MOSFET with body bias generator to eliminate intrinsic source-to-drain diode.

FIG. 7A shows an implementation of the dual output TMI synchronous boost converter using an N-channel MOSFET with body bias generator.

FIG. 7B shows an implementation of the dual output TMI synchronous boost converter using a grounded body N-channel MOSFET.

FIG. 8 shows a dual-output TMI boost and synchronous boost converter.

FIG. 9A shows a triple-output TMI synchronous boost converter.

FIG. 9B is a flowchart for a first algorithm for operating the boost converter of FIG. 9A.

FIG. 9C is a flowchart for a second algorithm for operating the boost converter of FIG. 9A.

FIG. 9D is a flowchart for a third algorithm for operating the boost converter of FIG. 9A.

FIG. 9E is a flowchart for a fourth algorithm for operating the boost converter of FIG. 9A.

FIG. 10 shows a dual-output TMI synchronous boost inverter.

FIG. 11 shows a digitally controlled triple-output TMI synchronous boost converter.

FIG. 12 shows an improved digitally controlled triple-output TMI synchronous boost converter.

### DETAILED DESCRIPTION OF THE PREFERRED EMBODIMENTS

As described previously, conventional non-isolated switching regulators require one single-winding inductor and corresponding dedicated PWM controller for each regulated output voltage. In contrast, this disclosure describes an inventive boost converter able to produce multiple independently-regulated outputs from one single-winding inductor.

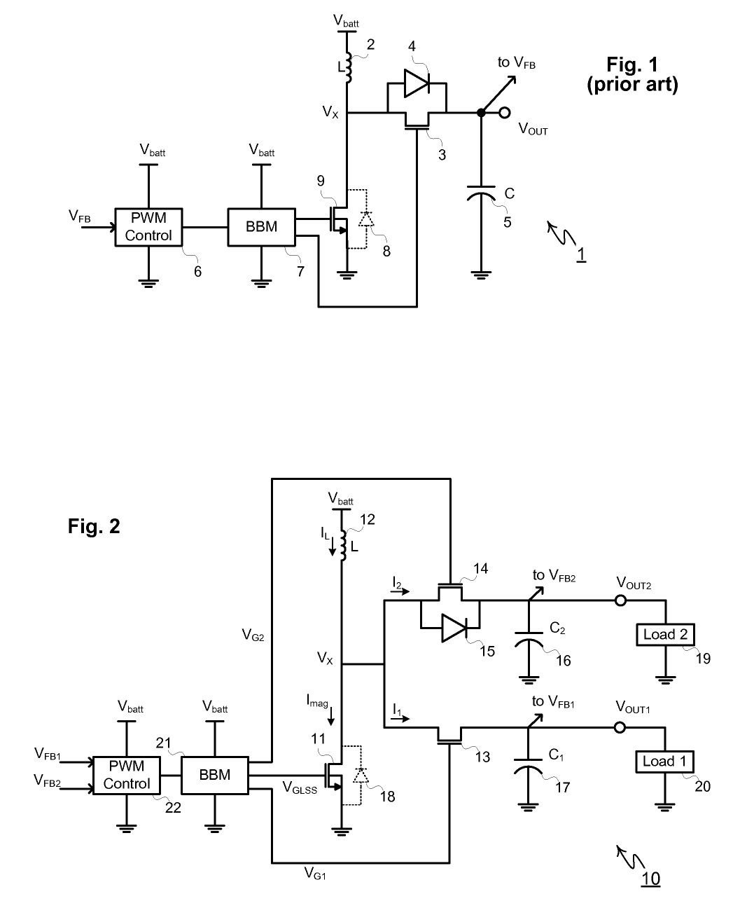

Shown in FIG. 2 for a two-output version, time-multiplexed-inductor boost converter 10 comprises low-side N-channel MOSFET 11, inductor 12, floating synchronous rectifier 14 with intrinsic source-to-drain diode 15, floating synchronous rectifier 13 with no source-to-drain diode, output filter capacitors 17 and 16 filtering outputs V_{OUT1} and V_{OUT2} and driving loads 20 and 1 9 respectively. Regulator operation is controlled by PWM-controller 22 driving break-before-make buffer 21, also referred to by the acronym BBM which in turn controls the on-time of MOSFETs 11, 13, and 14. PWM controller 22 may operate at fixed or variable frequency. Closed-loop regulation is achieved through feedback from the V_{OUT1} and V_{OUT2} outputs using corresponding feedback signals V_{FB1} and V_{FB2}. The feedback voltages may be scaled by resistor dividers (not shown) as needed. Low-side MOSFET 11 includes intrinsic P-N diode 18 shown by dotted lines, which under normal operation remains reverse biased and non-conducting.

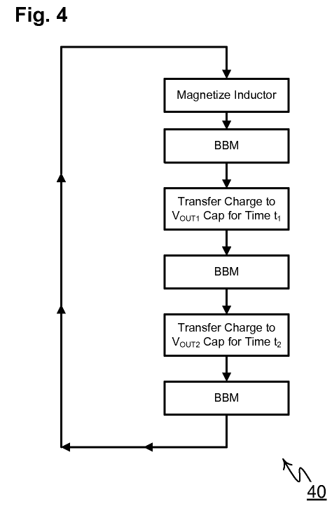

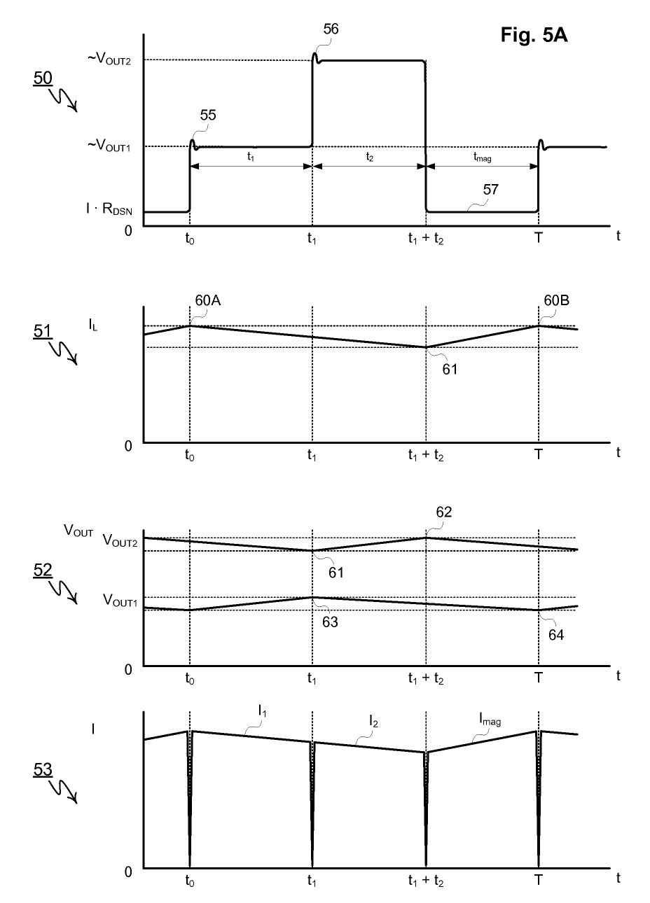

The operating principle for a boost converter with a time-multiplexed-inductor is sequential, magnetizing the inductor then transferring energy to each output one by one, before magnetizing the inductor again. This algorithm is illustrated in flow 40 of FIG. 4 for a dual-output converter with independently regulated outputs V_{OUT1} and V_{OUT2}.

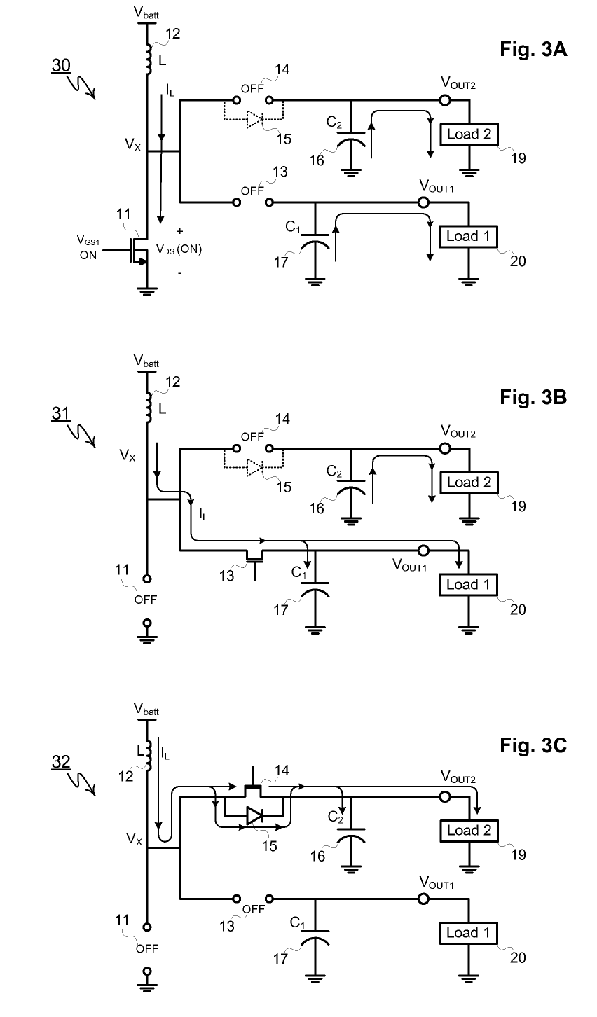

As an example implementation, dual-output converter 10 comprises time-multiplexed inductor 12 among the battery input V_{batt}, a first voltage output V_{OUT1}, and a second voltage output V_{OUT2} as illustrated in FIG. 3. In circuit 30 of FIG. 3A, inductor 12 is magnetized by turning on low-side N-channel MOSFET 11 during which time

Vₓ=V_{DS(on)}=I_{L}·R_{DSN(on)}

where I_{L}(t) is the time dependent inductor current and R_{DSN(on)} is the on-state resistance of low-side N-channel MOSFET 11 typically ranging from tens to hundreds of milliohms.

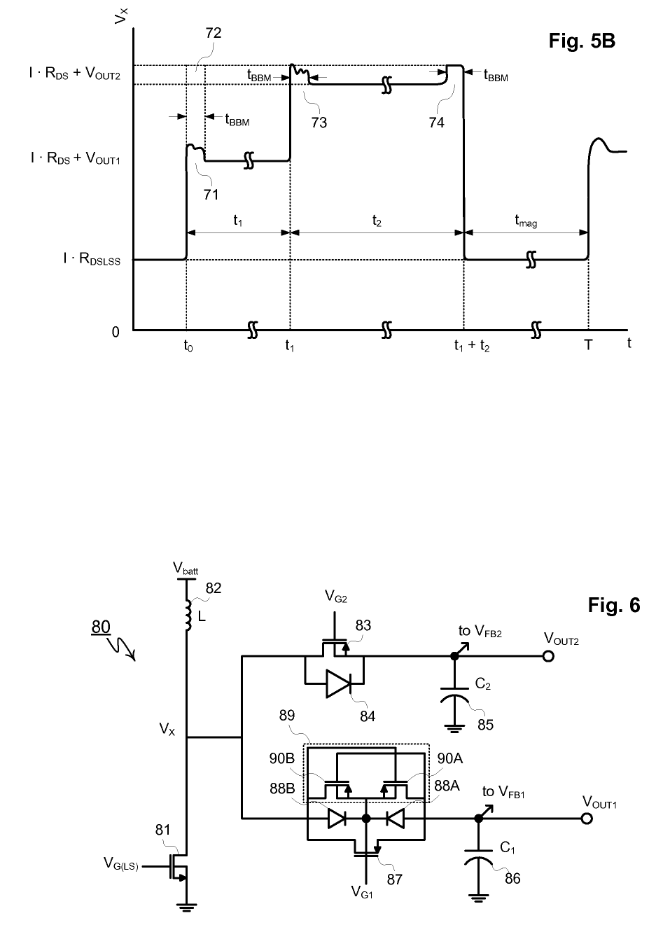

FIG. 5A illustrates the switching waveforms corresponding to operation of regulator 10 including Vₓ voltage graph 50, inductor current graph 51, output voltage graph 52 and MOSFET current graph 53. As shown the interval t_{mag} between (t₁+t₂) to T corresponds to magnetizing inductor 12. This magnetizing phase is also illustrated as an initial condition in the interval prior to time t₀. The interval between t₀ and t₁ of duration t₁ corresponds to transferring energy from the inductor to V_{OUT1}. Similarly, the interval between t₁ and (t₁+t₂) of duration t₂ corresponds to transferring energy from the inductor to V_{OUT2}.

As shown in graph 50 while I_{L} ramps, Vₓ maintains a potential 57 very close to ground and diode 15 remains reverse biased and non-conducting. The inductor current I_{L}(t)reaches its peak value 60A or 60B at the end of this first state of operation at time t₀ or at time (t₁+t₂) respectively. This interval of duration t_{mag} is herein referred to as the converter's magnetizing phase, an interval when all the energy needed to be delivered to the loads must be stored in the inductor. During this interval off MOSFETs 13 and 14 disconnect the converter's output from inductor 12 during which time capacitors 17 and 16 must supply loads 20 and 1 9, as evidenced by decay in the output voltages in graph 52.

The transition to the next phase involves turning off MOSFET 11 before turning on either synchronous rectifier MOSFET. This brief interval where all three MOSFETs are off, known as the break-before-make or BBM interval, is needed to insure that output capacitors 16 or 17 are not inadvertently shorted out during switching transitions. BBM operation therefore avoids an unwanted current spike known as “shoot-through current”, which degrades efficiency, increases noise, and possibly causes device damage.

Break-before-make intervals t_{BBM} typically range from nanoseconds to hundreds of nanoseconds depending on the design of BBM circuit, e.g. BBM gate drive buffer 21 in boost converter 10. Since BBM operation occurs only during transitions, however, it is not considered a converter “state”. Accordingly, short BBM intervals insure circuit and stray capacitance will damp rapid transitions on the Vₓ node, preventing unwanted voltage spikes. As shown in FIG. 5B, close-up 70 of the Vₓ waveform reveals that depending on capacitance, the Vₓ voltage may exhibit a small momentary increase shown by curve 71 or jump to a higher voltage 72 limited by the forward biasing of diode 15.

After the break-before-make interval in the second phase of operation illustrated by circuit 31 in FIG. 3B, the voltage at Vₓ flies up in response to the interruption of current in MOSFET 11. In tandem with this transition, one of the synchronous rectifiers, in this example MOSFET 13 are turned on directing inductor current I_{L} to the output Vₒᵤₜ₁, filter capacitor 17, and load 20. As shown in graph 50, at times t₀ and T the Vₓ voltage overshoots then settles on a value substantially equal to V_{OUT1}. Synchronous to this event, the current in inductor 12 is redirected from MOSFET 11 to MOSFET 13 as shown in graph 53 and IL at its peak value 60A, thereafter begins to decay.

After duration t₁, the time needed to charge capacitor 17 to a specified voltage 63 determined through feedback control from V_{OUT1}, the converter then exhibits another short break-before-make interval during which, depending on capacitance, the Vₓ voltage jumps to a higher voltage illustrated by transient 73 in FIG. 5B, where it is clamped to its maximum value by the momentary forward biasing of diode 15. As shown in graph 53 the inductor current I_{L}=I₁ is redirected from synchronous rectifier MOSFET 13 to MOSFET 14 to begin charging capacitor 16 of V_{OUT2}, whereby I₁→I₂. At this instant, V_{OUT1} reaches its peak voltage 63 and thereafter begins to decay, while V_{OUT2} reaches in minimum voltage 61 and thereafter begins to charge.

After duration t₂, i.e. at a time t=(t₁+t₂), capacitor 16 reaches its peak target voltage 62. Likewise, the current I_{L} in inductor 12 reaches its minimum current 61, a consequence of having charged both capacitors 16 and 17 over an interval of duration (t₁+t₂) without being refreshed. All MOSFETs are then turned off, and as shown in FIG. 5B, the Vₓ voltage momentarily increases to (V_{OUT2}+V_{f}), where V_{f} is the forward bias voltage across diode 15. Thereafter, low-side N-channel MOSFET 11 is turned on, inductor 11 is magnetized as its current ramps, and the cycle begins again.

In this manner, two outputs are regulated to two different voltages V_{OUT1} and V_{OUT2}, all powered from a single inductor. Since ΔQ=C·ΔV, then the charge refreshed on each output capacitor during its charging cycle is given by

$$Δ {V}_{OUT 1} = \frac{Δ Q}{{C}_{1}} = \frac{1}{{C}_{1}} {\int }_{{t}_{0}}^{{t}_{1}} {I}_{L} ( t ) \cdot d t$$

$$and$$

$$Δ {V}_{OUT 2} = \frac{Δ Q}{{C}_{2}} = \frac{1}{{C}_{2}} {\int }_{{t}_{1}}^{{t}_{1} + {t}_{2}} {I}_{L} ( t ) \cdot d t$$

The total energy in the inductor per cycle must be replenished during the magnetizing cycle, under closed loop feedback.

The maximum voltage of the Vₓ node for the time-multiplexed-inductor boost converter is determined by the highest output voltage V_{OUT2} plus the forward bias voltage V_{f} across the clamp diode, i.e. Vₓ (max)≦(V_{OUT2}+V_{f}). All MOSFETs need to be able to block Vₓ(max) in their off state.

P-channel Synchronous Rectification; Even though the low-side MOSFET used to magnetize the TMI boost converter's inductor is conveniently N-channel, the synchronous rectifier MOSFETs may be P-channel.

As shown in circuit 80 of FIG. 6, the highest voltage output V_{OUT2} can utilize a conventional P-channel MOSFET 83 with a source-body short as a synchronous rectifier. Synchronous rectifier MOSFET 83 must be oriented so that its source-to-drain diode 84 is oriented with its anode connected to inductor 82 and the drain of MOSFET 81, i.e. to the Vx node, and its cathode connected to the output V_{OUT2} and capacitor 85. Since Vₓ only exceeds V_{OUT2} when charging capacitor 85, then under the other operating conditions, diode 84 remains reversed biased. In this regard since V_{OUT1}>Vₓ, MOSFET 83 only requires unidirectional blocking in its off state. Gate bias control V_{G2} of P-channel 83 is easily implemented by pulling its gate to ground to turn on the MOSFET and connecting its gate to V_{OUT2} to shut it off.

The construction of synchronous rectifier MOSFET 87 connected to V_{OUT1} is altogether different. When N-channel 81 is conducting, Vₓ is near ground and V_{OUT1}>Vₓ. Conversely, when P-channel 83 is conducting, Vₓ=V_{OUT2} so that Vₓ>V_{OUT1} opposite in polarity to the prior case. As a result, MOSFET must in its off state block conduction bi-directionally, and can not include a parallel source-to-drain diode.

To prevent diode conduction, the body terminal of P-channel 87 is not shorted to either source or drain terminals, but instead is biased by body-bias-generator 89 comprising P-channel MOSFETs 90A and 90B with cross-coupled gates. Specifically, the source and drain terminals of P-channel 90A is connected between the body of MOSFET 87 and V_{OUT1} in parallel with P-N diode 88A. The source and drain terminals of P-channel 90B is connected between the body of MOSFET 87 and Vₓ in parallel with P-N diode 88B. The gates of MOSFETs 90A and 90B are cross coupled with the gate of MOSFET 90A connected to Vₓ and the gate of MOSFET 90B connected to V_{OUT1}. The N-type body connection of P-channel MOSFET 87 is shared with MOSFETs 90A and 90B and the cathodes of P-N diodes 88A and 88B.

Operation of BBG circuit 89 avoids forward biasing of the source-to-body and drain-to-body diodes 88A and 88B by shunting whichever one is forward biased with a conducting MOSFET, either 90A or 90B, only one of which will be in its “on” state at any given time. For example when Vₓ>V_{OUT1}, diode 88B is forward biased, but because the cross-coupled gate of P-channel 90B is negative with respect to its source, MOSFET 90B turns on, shorting the body of MOSFET 87 to the Vₓ terminal and in so doing shorting out diode 88B. With its cathode a more positive potential than its anode, P-N diode 88A is reverse biased and does not conduct current. Similarly the gate of P-channel 90A is more positive than its source so that MOSFET 90A remains off.

Since BBG circuit 89 is symmetric with respect to source and drain, it operates similarly in the opposite polarity bias. Specifically when V_{OUT1}>Vₓ, diode 88A is forward biased, but because the cross-coupled gate of P-channel 90A is negative with respect to its source, MOSFET 90A turns on, shorting the body of MOSFET 87 to the V_{OUT1} terminal and in so doing shorting out diode 88A. With its cathode a more positive potential than its anode, P-N diode 8BA is reverse biased and does not conduct current. Similarly, since the gate of P-channel 90B is more positive than its source, MOSFET 90B remains off.

So no matter which terminal is biased more positively, the P-N diodes 88A and 88B intrinsic to the construction of MOSFET 87 remain reversed biased and off. While the concept of a body bias generator, sometimes called a “body snatcher”, is by itself not new, its role in multi-output converter 80 is critical to prevent clamping of Vₓ to a voltage less than V_{OUT2}. The implementation of body bias generator circuit 89 is easily integrated into non-isolated CMOS wafer manufacturing using common P-type substrates, because the body region of MOSFET 87 comprises an N-type well, which is naturally isolated from the common P-type substrate.

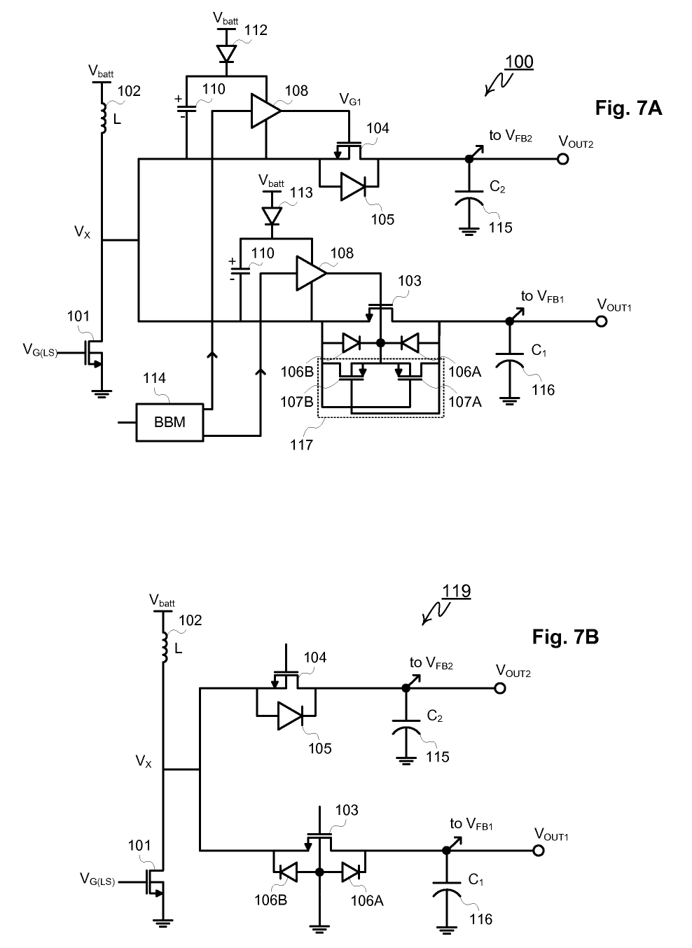

N-channel Synchronous Rectiflcation; FIG. 6 illustrated a TMI boost converter employing multiple P-channel synchronous rectifiers; it is also possible to employ N-channel MOSFETs to perform the synchronous rectifier function instead. An all N-channel implementation 100 of a TMI boost converter is illustrated in FIG. 7A comprising low-side N-channel MOSFET 101, inductor 102, a first N-channel synchronous rectifier MOSFET 104 with intrinsic P-N source-to-drain parallel diode 105, a second N-channel synchronous rectifier MOSFET 103 with intrinsic P-N source-to-body and drain-to-body diodes 106A and 106B and with body-bias generator circuit 117, and output filter capacitors 115 and 116. The remaining components 108 through 114 comprise circuitry performing gate drive of the N-channel synchronous rectifier MOSFETs 103 and 104.

Operation of the dual output time-multiplexed boost converter 100 is algorithmically identical to the previously described converters 10 and 80, involving a sequence turning on low-side MOSFET 101 and magnetizing inductor 102; turning off MOSFET 101 and turning on synchronous rectifier 103 charging output capacitor 116 and delivering energy to output V_{OUT1}, turning off MOSFET 103 and turning on synchronous rectifier 104 charging output capacitor 115 and delivering energy to output V_{OUT2}, then repeating the entire sequence.

Like converter 80 using P-channel synchronous rectifiers, only the synchronous rectifier MOSFET connected to the highest output voltage V_{OUT2} may include an intrinsic P-N diode 105 allowed to conduct in tandem with synchronous rectifier MOSFET 104. All other synchronous rectifiers connected to lower output voltages must be free of any forward-biased diodes in parallel with the MOSFET's source-to-drain terminals.

BBG circuit 117 comprising cross coupled N-channel MOSFETs 107A and 107B achieves this purpose, i.e. to prevent either diode 106A or 106B from conducting current in forward bias. Despite being implemented with N-channel MOSFETs instead of P-channel devices, operation of body-bias-generator circuit 117 functions in a similar manner to the previously described BBG circuit 89 by shorting out any forward biased diode so that only a reverse-biased diode appears across the MOSFET's source-to-drain terminals no matter what polarity is applied.

For example, when Vₓ>V_{OUT1}, i.e. when inductor 102 is transferring energy to one of the converter's outputs, then the resulting positive gate bias on its gate, turns on BBG MOSFET 107A connecting the body of MOSFET 103 to V_{OUT1}, and in so doing shorting out forward-biased diode 106A. With its cathode biased at Vₓ and its anode tied to the more negative V_{OUT1} terminal, the remaining diode 106B is therefore reverse biased and does not conduct current.

Conversely, when V_{OUT1}>Vₓ, e.g. when inductor 102 is being magnetized, then the positive gate bias on the gate of 107B turns it on connecting the body of MOSFET 103 to Vₓ, and in so doing shorting out forward-biased diode 106B. With its cathode biased at V_{OUT1} and its anode tied to the more negative Vₓ terminal, the remaining diode 106A is therefore reverse biased and does exhibit unwanted current conduction.

As shown, the P-type body of N-channel MOSFET 103 shares an electrical connection with the P-type body connection of N-channel BBG MOSFETs 107A and 107B and the anodes of diodes 106A and 106B. As a result, devices 103, 106 and 107 may share a common floating P-type region or well. Unfortunately unlike P-channel BBG implementation 89, N-channel BBG circuit 117cannot easily be integrated since most IC fabrication processes comprise non-isolated CMOS with a grounded P-type substrate.

Sans isolation, any P-type region is unavoidably grounded and cannot float or be biased in response to changing conditions. As such the N-channel BBG circuit 117 can only be integrated into IC processes offering electrical isolation and “floating” N-channel MOSFETs, processes traditionally more complex, more expensive, and less available from commercial wafer foundries.

FIG. 7B illustrates one remedy to this dilemma, where N-channel MOSFET 103 in circuit 119 has its body connected to ground so that diodes 106A and 106B always remain reverse biased, eliminating the need for a BBG circuit requiring floating N-channel MOSFETs and electrical isolation. The problem with grounding the body of N-channel 103 is an unwanted increase in threshold due to a phenomenon known as the body effect, characterized by an increase in a MOSFET's threshold resulting from reverse biasing the transistor's source-to-body junction. The increase is roughly proportional to the square root of the junction's reverse biasing, whereby

V_{tN}≈V_{toN+√}\sqrt{V_{SBN}}=V_{toN}+\sqrt{V_{OUT1}}

From this equation if V_{OUT1} is 3V, the threshold voltage of synchronous rectifier MOSFET 103 will increase by the square root of 3V, i.e. V_{tN} will increase by 1.7V, and thereby reduce the MOSFET's effective gate drive (V_{GS}−V_{tN}) and increase the area-specific on-resistance of the synchronous rectifier power MOSFET. In such cases N-channel gate drive becomes a key consideration.

The gate drive circuitry in converter 100 includes bootstrap capacitor 110, floating gate drive buffer 108, and bootstrap diode 112 driving N-channel synchronous rectifier MOSFET 104 and bootstrap capacitor 111, floating gate drive buffer 109, and bootstrap diode 113 driving N-channel synchronous rectifier MOSFET 103, controlled by break-before-make circuit BBM 114 to prevent both synchronous rectifier MOSFETs 103 and 104 from conducting simultaneously. Bootstrap operation involves charging bootstrap capacitors 110 and 111 to a voltage (V_{batt}−V_{f}) whenever Vₓ is near ground and then using the charge on the bootstrap capacitors to power the floating gate buffers 108 and 109. When synchronous rectifier MOSFET 103 is conducting, Vₓ≈V_{OUT1} and the potential on the positive terminal of capacitor 111 powering buffer 109 initially has a corresponding potential (V_{OUT1}+V_{batt}−V_{f}) and discharges as it drives buffer 109. Since they are all referenced to potential VX, the net voltage powering buffer 109 and MOSFET 103 is (V_{batt}−V_{f}).

Similarly, when synchronous rectifier MOSFET 104 is conducting, Vₓ≈V_{OUT2} and the potential on the positive terminal of capacitor 110 powering buffer 108 initially has a corresponding potential (V_{OUT2}+V_{batt}−V_{f}) and discharges as it drives buffer 103. Since they are all referenced to potential Vₓ, the net voltage powering buffer 108 and MOSFET 104 is (V_{batt}−V_{f}).

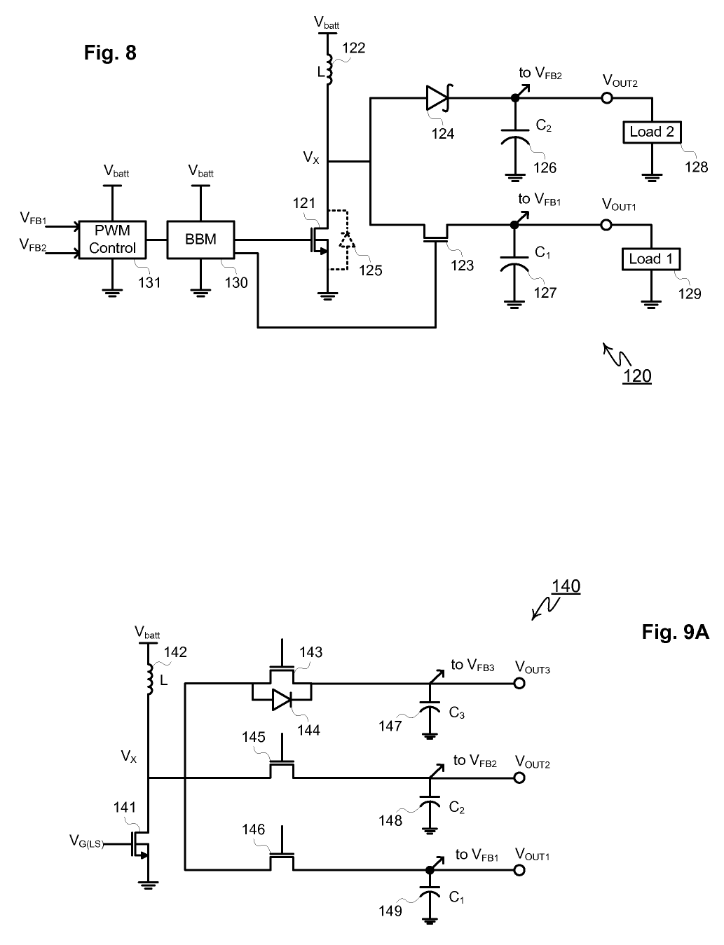

Hybrid Synchronous & Asynchronous Rectifier Converter: FIG. 8 illustrates a simplified dual-output TMI boost converter 120 combining a single synchronous rectifier 123 with Schottky diode 124. In converter 120, PWM controller 131, controls the on time of MOSFETs 121 and 123 and output voltages V_{OUT2} and V_{OUT1}. Operation involves turning on MOSFET 121, magnetizing inductor 121 then turning off MOSFET 121 and turning on synchronous rectifier MOSFET 123 to charge capacitor 127. During this transition, BBM circuit 130 prevents simultaneous conduction of MOSFETs 121 and 123.

After charging capacitor 127 to its regulated voltage, synchronous rectifier MOSFET 123 is turned off. At that time Vₓ, forced by inductor 122, flies up above V_{OUT2} and forward biases Schottky 124 charging capacitor 126. After V_{OUT2} reaches its regulated voltage, PWM controller 131 turns on MOSFET 121 and thereafter the cycle repeats. Low-side MOSFET 121 and synchronous rectifier MOSFET 123 form a synchronous boost converter. Low side MOSFET and Schottky diode 124 form a conventional non-synchronous boost converter. Time-multiplexed-inductor boost converter 120 therefore comprises a hybrid of a conventional boost and a synchronous boost converter and voltage regulator.

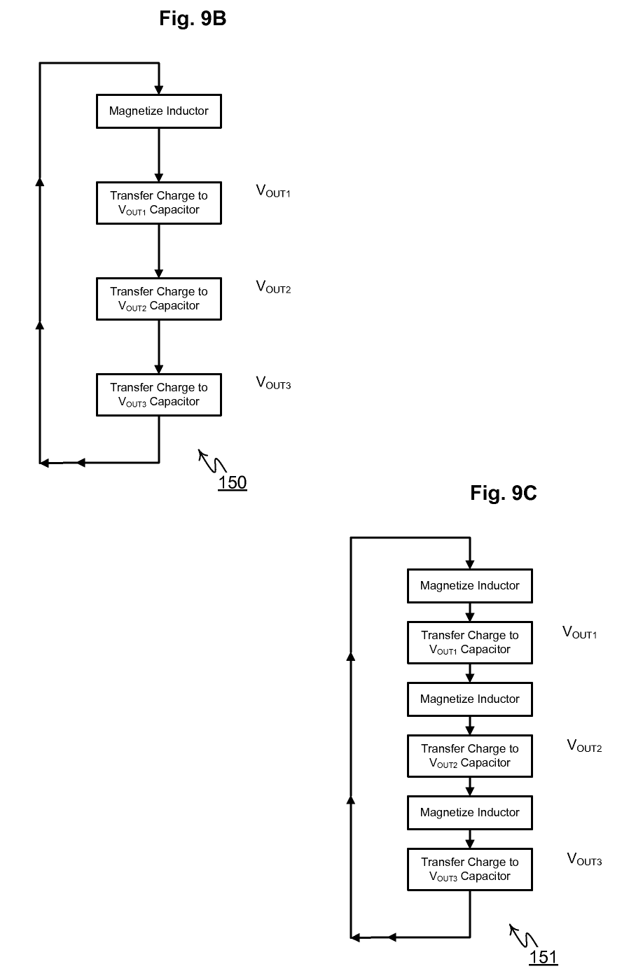

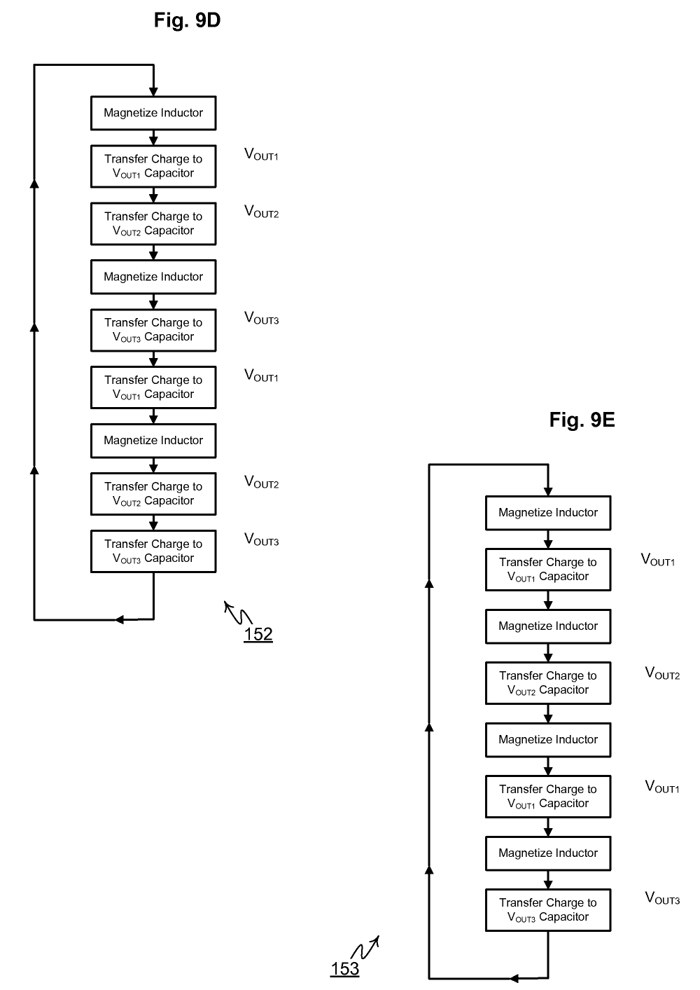

Multi-Channel TMI Boost Converter: FIG. 9A illustrates a three output TMI boost converter 140 comprising N-channel MOSFET 141, inductor 142, three synchronous rectifiers 146,145 and 143 and capacitors 149,148, and 147 corresponding to independently regulated outputs V_{OUT3}, V_{OUT2}, and V_{OUT1}. MOSFET 143 powering the highest positive output voltage V_{OUT3} includes parallel P-N diode rectifier 144.

Time multiplexing of inductor 142 alternates transferring energy among all three outputs and magnetizing inductor 142. In algorithm 150 of FIG. 9B, the four states are sequential with the inductor being magnetized only after transferring energy to all three outputs. The algorithm comprises magnetizing inductor 142, transferring energy to capacitor 149 of V_{OUT1}, transferring energy to capacitor 148 of V_{OUT2}, transferring energy to capacitor 147 of V_{OUT3}, and thereafter repeating the entire cycle starting with magnetizing the inductor.

This method suffers the worst ripple in inductor current but uniformly refreshes the output capacitors at the highest possible rate. As a shorthand notation to describe various algorithms, herein we define M to refer to the step of magnetizing the inductor and a number to represent the specific number of the output refreshed before magnetizing the inductor again. Using such nomenclature then this algorithm can be referred to as M123, i.e. magnetize the inductor, then transfer energy to three different outputs in succession, then repeat.

In another embodiment of this invention shown in algorithm 151 of FIG. 9C, the inductor is magnetized immediately after transferring energy to each output. The algorithm comprises magnetizing inductor 142, transferring energy to capacitor 149 Of V_{OUT1}, magnetizing inductor 142, transferring energy to capacitor 148 of V_{OUT2}, magnetizing inductor 142, transferring energy to capacitor 147 of V_{OUT3}, and thereafter repeating the entire cycle. This method exhibits the least ripple in inductor current but allows the output capacitor voltage to sag more before being refreshed, increasing output voltage ripple. By shorthand, this algorithm follows a pattern of M1M2M3.

In algorithm 152 shown in FIG. 9D, the inductor is magnetized every third phase, i.e. after transferring energy to two outputs. The algorithm comprises magnetizing inductor 142, transferring energy to capacitor 149 of V_{OUT1}, transferring energy to capacitor 148 of V_{OUT2}, magnetizing inductor 142, transferring energy to capacitor 147 of V_{OUT3}, transferring energy to capacitor 149 Of V_{OUT1}, magnetizing inductor 142, transferring energy to capacitor 148 of V_{OUT2}, transferring energy to capacitor 147 of V_{OUT3}, then repeating the entire cycle. Such an approach offers a compromise between output voltage ripple and inductor input current ripple. This algorithm follows the pattern M2M31M23.

In many applications one specific supply needs to meet tight voltage regulation tolerances while the others do not, either because they are not critical or because they are less subject to load transients. FIG. 9E illustrates such a “preferred output” algorithm 153 where one particular output is refreshed frequently compared to the other two. In the shorthand nomenclature defined herein, the preferred output algorithm follows a pattern M1M2M1M3.

As illustrated any number of multiplexing algorithms may be employed to implement a multi-output time-multiplexed inductor boost converter. For example an alternative preferred output algorithm could comprise a M1M123 pattern. If two outputs are preferred and only one is not critical, a “neglected output” algorithm may comprise M12M12M3 where output 3 is given the opportunity to recharge only ⅛^{th} of the cycle.

In all the examples given the algorithm is decided by the controller without consideration of the load. While the time that the inductor stays connected to any given output varies in response to feedback, the frequency by which it is give the chance to refresh its output capacitor depends on the algorithm executed by the controller. This approach, where the controller decides when to “ask” if a particular output needs to be connected to the inductor and have its capacitor refreshed, can be considered as a “polled” system, i.e. the controller polls each load when it chooses and only then has a chance to refresh its sagging capacitor voltage. Larger capacitors decay in voltage more slowly, but their voltage decays over time none-the-less.

In another approach using feedback, the PWM controller can give priority to any output needing to be refreshed. Referring again to converter 10 in FIG. 2, the two outputs V_{OUT1} and V_{OUT2} are fed back into controller 22 with corresponding signals V_{FB1} and V_{FB2}. As described the on-time t₁ and t₂ for MOSFETs 13 and 14 is determined by using negative feedback to achieve stable closed loop control.

This voltage feedback information may also be used however to dynamically adjust the regulator's algorithm. For example, if a time-multiplexing algorithm such as M1M2 giving even treatment to both outputs is being used, and if V_{OUT1} begins to drop out of regulation for several cycles, the converter can dynamically adjust its algorithm to help correct the problem. During intervals where V_{OUT1} is experiencing transients and difficulty in maintaining regulation, the controller could switch to a “preferred output” algorithm such as M1M12 so that output one gets increased attention.

Another method is to use the feedback information to generate an interrupt, i.e. to detect a condition that requires priority attention and to suspend normal operations to the condition is remedied. For example if V_{OUT1} were to drop below the target output voltage by 10%, to immediately jump to the condition where synchronous rectifier 13 is turned on and capacitor 17 is refreshed by current from inductor 12. By responding immediately to events and changing conditions that cannot be foreseen or predicted, the interrupt driven TMI boost converter can respond more quickly to dynamic changes than using polled implementations. If more than one output can generate priority interrupts simultaneously, an interrupt priority list or hierarchical logic must be included to settle the conflict and determine how the regulator should react.

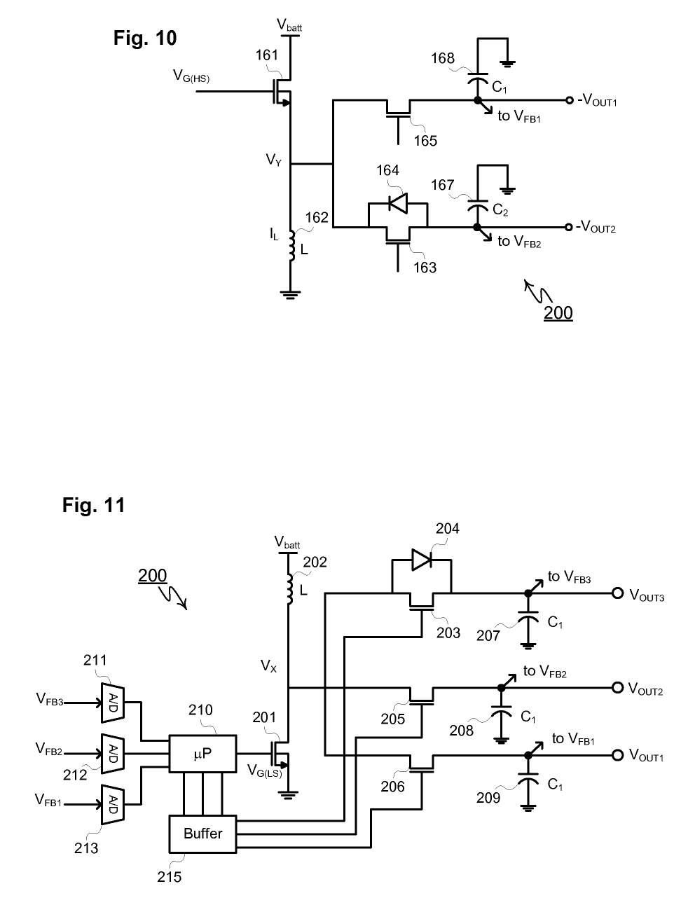

Inverting Multi-Output TMIBoost Converters: Thus far, the TMI circuit-topologies disclosed herein are able to generate multiple positive output voltages from a single inductor. The time-multiplexed-inductor works equally well in inverting boost converters, or “inverters”. Schematic 160 in FIG. 10 illustrates a dual-output TMI inverter made in accordance with this invention. Instead of employing a low-side MOSFET and a battery connected inductor like a boost converter, the inverter reverses these two components, with MOSFET 161 connected to the positive battery input, i.e. on the high-side, and inductor 162 connected to ground. A P-channel MOSFET 161 is shown, since P-channel MOSFETs are easier to drive as high-side devices than N-channels are. With appropriate floating gate drive circuitry, an N-channel may be substituted for MOSFET 161 without changing the operation of TMI inverter 160.

Whenever high-side MOSFET 161 is conducting, the inductor-current IL ramps while inductor 162 is magnetized and stores energy. The connection of inductor 162 to high-side MOSFET 161, labeled herein as V_{y}, has a maximum positive voltage of (V_{batt}−I_{L}·R_{DSP}), a voltage approximately equal to V_{batt}. Whenever high-side MOSFET 161 is shut off, the voltage at V_{y} immediately jumps to a negative value. Left unclamped, the large negative V_{y} voltage would cause MOSFET 161 to go into avalanche breakdown. But since diode 164 is present between the −V_{OUT2} and V_{y} nodes, the V_{y} voltage is limited to a maximum negative potential of (−V_{OUT2}−V_{f}), where V_{f} is the forward biased voltage drop across P-N junction 164.

In addition to diode 164, synchronous rectifier MOSFETs 163 and 165 connect the inductor's V_{y} node to filter capacitors 167 and 168 and to outputs −V_{OUT2} and −V_{OUT1}, respectively. These MOSFETs may be N-channel or P-channel, but except for MOSFET 163 connected to most negative output −V_{OUT2}, must be constructed free of any source-to-drain P-N diodes. For either N-channel or P-channel the unwanted parasitic diodes may be eliminated using the same techniques previously described for positive TMI boost converters including the body-bias-generator circuit method. Alternatively an N-channel MOSFET with its body connected to a more positive supply rail such as V_{batt} or even ground may be used.

Operation of dual output TMI inverter 160 requires magnetizing inductor 162, then after shutting off high side MOSFET 161, turning on synchronous rectifier MOSFET 165 and charging 168 to a specified voltage controlled by negative feedback V_{FB1}. During this interval V_{y}=−V_{OUT1}. After a time t₁, MOSFET 165 is shut off and a second synchronous rectifier MOSFET 163 is turned on allowing inductor voltage V_{y} to jump to even a more negative voltage −V_{OUT2} and charge capacitor 167. When the voltage reaches a specified voltage determined by the PWM controller and feedback signal V_{FB2} synchronous rectifier MOSFET 163 is turned off, high side MOSFET 161 is turned on and the cycle repeats itself.

In this way TMI inverter 160 produces multiple negative regulated output voltages from a single inductor.

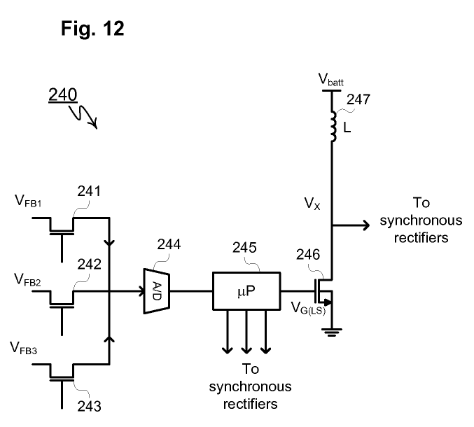

Digitally-Controlled Algorithmic TMI Converters: In the previous examples, the multiplexing algorithms were described in terms of hardware implementations and hard-wired mixed-signal circuitry. The algorithms of a TMI boost converter can also be implemented using digital techniques, programmable state machines, microprocessors or microcontrollers. FIG. 11 illustrates on such implementation 200 comprising microprocessor 210 controlling a three output time-multiplexed-inductor converter and regulator made in accordance with this invention. The fundamental elements of the TMI converter, namely low-side N-channel MOSFET 201, synchronous rectifier MOSFETs 206, 205 and 203, and filter capacitors 207, 208, 208 generate the regulated outputs V_{OUT3}, V_{OUT2}, and V_{OUT1}, respectively from a single inductor 202.

Gate control and timing of MOSFETs 201, 203, 205 and 206 are controlled by software programs within microprocessor or digital controller 210 executing the various multiplexing algorithms described previously. The algorithm decides when to turn each MOSFET on and off in sequence and also can perform any break-before-make timing as need be. While the V_{GLSS} output of μP 210 may drive grounded N-channel 201 directly, the V_{G3}, V_{G2}, and V_{G1} signals driving synchronous rectifier MOSFETs 203, 205 and 206 may require level shifting as illustrated by gate buffer 215.

To regulate the voltage at the various outputs and control the MOSFETs' on times, the controller requires voltage feedback V_{FB3}, V_{FB2}, and V_{FB1} from their respective outputs. To be able to utilize voltage feedback, the analog signals must be digitized as illustrated by analog-to-digital converters 211, 212 and 213 feeding microprocessor 210. In practice these converters may be included inside microcontroller 210. As shown, voltage regulator 200 requires one A/D converter for each output voltage.

In an alternative embodiment shown in circuit 240 of FIG. 12, a single A/D converter 244 can be used to monitor all three output voltages using MOSFETs 241, 242, 243 to multiplex feedback signals V_{FB3}, V_{FB2}, V_{FB1} into controller 245 one at a time in sequence. In one embodiment of the invention, the A/D feedback multiplexing occurs in tandem with the multiplexing of the synchronous rectifier connected to each output.

TMI Boost Output Voltages: In the described algorithms, there is no presumption on which output voltages are higher or lower than others, nor is their any preferred sequence in charging the various outputs. The TMI boost can be designed to charge the lower voltage outputs first, and finish with the highest, or vice versa. It can also charge the highest output voltage first, the lowest second and an intermediate voltage last. Any voltage charging sequence is possible with the TMI boost converter.

One important restriction is that only a synchronous rectifier MOSFET tied to the highest output voltage can have a P-N diode parallel to its source-drain terminals. All other positive outputs except for the most positive one must be free of source-drain diodes, e.g. using either the grounded body or BBG circuit techniques disclosed herein.

Theoretically the highest voltage does not need a diode either. If however all MOSFETs are turned off for an extended duration of time after magnetizing the inductor, the Vₓ voltage will fly up without limit until some PN junction breaks down. This avalanche breakdown, most likely to occur in the low side N-channel MOSFET, will force the MOSFET to absorb all the energy stored in the inductor. This condition, known as unclamped inductive switching, represents a loss of energy and efficiency, and creates a potentially damaging condition for any power MOSFETs connected to the Vₓ node, especially the N-channel low-side MOSFET which sees the highest V_{DS} potential.

If a P-N diode is present across a synchronous rectifier MOSFET like in conventional boost converter 1 of FIG. 1, the minimum output voltage for its output is necessarily V_{batt}, because the diode forward biases pulling the output up to V_{batt} as soon as power is applied to the regulator's input terminals. In the disclosed TMI boost converter, however, outputs where no P-N diode is present across its synchronous rectifier are not restricted to operation only above V_{batt}. Adapting a boost converter's topology for step-down voltage regulation is the subject of a copending patent entitled “High-Efficiency Up-Down and Related DC/DC Converters” (concurrently filed herewith) and is included herein by reference.

This disclosure describes the application of a time-multiplexed-inductor in both positive and negative output boost converters. In a related patent entitled “Dual-Polarity Multi-Output DC/DC Converters and Voltage Regulators” and concurrently filed herewith, a converter capable of producing both positive and negative voltage simultaneously from a single inductor is described and is incorporated herein by reference.

What is claimed is:

1. A switching converter that comprises:
an inductor connected between a supply voltage and a node V.;
a low-side switch connected between the node Vₓ and ground;
a first high-side switch connected between the node Vₓ and an a first load; and
a second high-side switch connected between the node Vₓ and a second load.

2. A switching converter as recited in claim 1 that further comprises a first output capacitor connected in parallel with the first load and a second output capacitor connected in parallel with the second load.

3. A switching converter as recited in claim 1 that further comprises a control circuit connected to drive the low-side switch, the first high-side switch and the second high-side switch in a repeating sequence that includes:
a first phase where the inductor is charged between the supply voltage and ground;
a second phase where the inductor supplies current to the first load; and
a third phase where the inductor supplies current to the second load.

4. A switching converter as recited in claim 3 in which the repeating sequence has the following form: first phase, second phase, third phase, first phase, second phase, third phase.

5. A switching converter as recited in claim 3 in which the repeating sequence has the following form: first phase, second phase, first phase, third phase, first phase, second phase, first phase, third phase.

6. A switching converter as recited in claim 3 that further compromises a feedback circuit configured to generate a feedback signal that is a function of the voltage or current supplied to at least one of the loads and in which the control circuit is configured to vary the duration of at least one of the first phase, second phase or third phase in response to the feedback signal.

7. A switching converter as recited in claim 3 that further compromises a feedback circuit configured to generate a feedback signal that is a function of the voltage or current supplied to at least one of the loads and in which the control circuit is configured to vary the frequency of repetition of the first phase, second phase and third phase in response to the feedback signal.

8. A switching converter as recited in claim 3 that further compromises a feedback circuit configured to generate a feedback signal that is a function of the voltage or current supplied to at least one of the loads and in which the control circuit is configured to skip the first phase, second phase or third phase in response to the feedback signal.

9. A switching converter as recited in claim 1 in which the low-side switch is an N-channel MOSFET device.

10. A switching converter as recited in claim 1 in which at least one of the first and second high-side switches is a P-channel MOSFET device.

11. A switching converter as recited in claim 10 in that further comprises a body-bias generator connected to supply a bias voltage to the P-channel MOSFET device.

12. A switching converter as recited in claim 1 in which at least one of the first and second high-side switches is an N-channel MOSFET device.

13. A switching converter as recited in claim 12 in that further comprises a bootstrap circuit connected to boost the voltage supplied to the gate of the N-channel MOSFET device.

14. A switching converter that comprises:
an inductor connected between a supply voltage and a node V,;
a low-side switch connected between the node Vₓ and ground;
a first high-side switch connected between the node Vₓ and an a first load; and
a diode connected between the node Vₓ and a second load.

15. A switching converter as recited in claim 14 that further comprises a first output capacitor connected in parallel with the first load and a second output capacitor connected in parallel with the second load.

16. A switching converter as recited in claim 14 that further comprises a control circuit connected to drive the low-side switch and the first high-side switch in a repeating sequence that includes:
a first phase where the inductor is charged between the supply voltage and ground;
a second phase where the inductor supplies current to the first load; and
a third phase where the inductor supplies current to the second load.

17. A switching converter as recited in claim 16 in which the repeating sequence has the following form: first phase, second phase, third phase, first phase, second phase, third phase.

18. A switching converter as recited in claim 16 in which the repeating sequence has the following form: first phase, second phase, first phase, third phase, first phase, second phase, first phase, third phase.

19. A switching converter as recited in claim 16 that further compromises a feedback circuit configured to generate a feedback signal that is a function of the voltage or current supplied to at least one of the loads and in which the control circuit is configured to vary the duration of at least one of the first phase, second phase or third phase in response to the feedback signal.

20. A switching converter as recited in claim 16 that further compromises a feedback circuit configured to generate a feedback signal that is a function of the voltage or current supplied to at least one of the loads and in which the control circuit is configured to vary the frequency of repetition of the first phase, second phase and third phase in response to the feedback signal.

21. A switching converter as recited in claim 16 that further compromises a feedback circuit configured to generate a feedback signal that is a function of the voltage or current supplied to at least one of the loads and in which the control circuit is configured to skip the first phase, second phase or third phase in response to the feedback signal.

22. A switching converter as recited in claim 14 in which the low-side switch is an N-channel MOSFET device.

23. A switching converter as recited in claim 14 in which the first high-side switch is a P-channel MOSFET device.

24. A switching converter as recited in claim 23 in that further comprises a body-bias generator connected to supply a bias voltage to the P-channel MOSFET device.

25. A switching converter as recited in claim 1 in which the first high-side switch is an N-channel MOSFET device.

26. A switching converter as recited in claim 25 in that further comprises a bootstrap circuit connected to boost the voltage supplied to the gate of the N-channel MOSFET device.

27. A switching converter that comprises:
a low-side switch connected between a supply voltage and a node Vₓ;
an inductor connected between a supply voltage and a node Vₓ;
a first high-side switch connected between the node Vₓ and an a first load; and
a second high-side switch connected between the node Vₓ and a second load.

28. A switching converter as recited in claim 27 that further comprises a first output capacitor connected in parallel with the first load and a second output capacitor connected in parallel with the second load.

29. A switching converter as recited in claim 27 that further comprises a control circuit connected to drive the low-side switch, the first high-side switch and the second high-side switch in a repeating sequence that includes:
a first phase where the inductor is charged between the supply voltage and ground;
a second phase where the inductor supplies current to the first load; and
a third phase where the inductor supplies current to the second load.

30. A switching converter as recited in claim 29 in which the repeating sequence has the following form: first phase, second phase, third phase, first phase, second phase, third phase.

31. A switching converter as recited in claim 29 in which the repeating sequence has the following form: first phase, second phase, first phase, third phase, first phase, second phase, first phase, third phase.

32. A switching converter as recited in claim 29 that further compromises a feedback circuit configured to generate a feedback signal that is a function of the voltage or current supplied to at least one of the loads and in which the control circuit is configured to vary the duration of at least one of the first phase, second phase or third phase in response to the feedback signal.

33. A switching converter as recited in claim 29 that further compromises a feedback circuit configured to generate a feedback signal that is a function of the voltage or current supplied to at least one of the loads and in which the control circuit is configured to vary the frequency of repetition of the first phase, second phase and third phase in response to the feedback signal.

34. A switching converter as recited in claim 29 that further compromises a feedback circuit configured to generate a feedback signal that is a function of the voltage or current supplied to at least one of the loads and in which the control circuit is configured to skip the first phase, second phase or third phase in response to the feedback signal.

35. A switching converter as recited in claim 27 in which the low-side switch is an N-channel MOSFET device.

36. A switching converter as recited in claim 27 in which at least one of the first and second high-side switches is a P-channel MOSFET device.

37. A switching converter as recited in claim 36 in that further comprises a body-bias generator connected to supply a bias voltage to the P-channel MOSFET device.

38. A switching converter as recited in claim 27 in which at least one of the first and second high-side switches is an N-channel MOSFET device.

39. A switching converter as recited in claim 38 in that further comprises a bootstrap circuit connected to boost the voltage supplied to the gate of the N-channel MOSFET device.
